(19) United States
(12) Patent Application Publication
(10) Pub. No.: US 2009/0108729 A1
(43) Pub. Date: Apr. 30, 2009

(54) Magnetic Field Compensation Apparatus for Cathode Ray Tube

(76) Inventors: Istvan Gorog, Lancaster, PA (US); Robert Lloyd Barbin, Henderson, NV (US)

Correspondence Address: Robert D. Shedd;Thomson Licensing LLC, PO Box 5312, PRINCETON, NJ, 08543-5312, US

(21) Appl. No.: 10/584,685

(22) PCT Filed: Dec. 17, 2004
(86) PCT No.: PCT/US04/42457

§ 371 Date: Jun. 28, 2006

Related U.S. Application Data
(60) Provisional application No. 60/534,458, filed on Jan. 6, 2004.

(51) Int. Cl. H01J 29/70

(52) U.S. Cl. 313/440

(57) ABSTRACT

A cathode ray tube (CRT) having a glass envelope is disclosed. The glass envelope is formed of a rectangular faceplate panel and a tubular neck connected thereto by a funnel. An electron gun is positioned in the neck for directing electron beams toward the faceplate panel. A yoke is positioned in the neighborhood of the funnel-to-neck junction. The yoke has windings configured to apply a horizontal deflection yoke field and a vertical deflection yoke field to the beams. At least one magnetic field sensor is located near the glass envelope for sensing an ambient magnetic field environment of the CRT. A controller receives a signal from the magnetic field sensor. Register correction coils are mounted in the vicinity of the neck and are dynamically controlled by the controller to shift the beams. Quadrupole coils are applied to the neck and have adjacent poles of alternating polarity such that the resultant magnetic field being dynamically controlled by the controller based on the magnetic field sensor signal moves outer ones of the beams to correct the misconvergence caused by the register correction.

### CROSS-REFERENCE TO RELATED APPLICATIONS

This application claims the benefit of U.S. Provisional Patent Application Ser. No. 60/534,458, entitled “Magnetic Field Compensation Apparatus for Cathode Ray Tube” and filed Jan. 6, 2004, which is incorporated by reference herein in its entirety.

### FIELD OF THE INVENTION

The invention is related to Cathode Ray Tubes (CRT) and more particularly to a magnetic field compensation system for use in such CRT.

### BACKGROUND OF THE INVENTION

The color rendition of a CRT image can be affected by the ambient magnetic field in the vicinity of the CRT. This ambient field is generally caused by the Earth's magnetic field and can be affected by local magnetic fields and magnetic materials in the area. This field can be considered to have a vertical component and a horizontal component. The horizontal component is normally oriented North to South. In a given location the relationship of the vertical component with respect to the path of the CRT electron beams is relatively constant. However, the effect of the horizontal component on the electron beams changes dramatically as the orientation of the CRT is changed, for example from East to West.

In a conventional CRT with the inline electron guns aligned in a horizontal plane and the phosphor stripes oriented vertically, the vertical component of the Earth's ambient field deflects the beam horizontally affecting the register of the beam to the phosphor stripe, while the horizontal component deflects the beam along the phosphor stripe without significantly affecting the register. Since the vertical fields are relatively constant and not affected by the CRT orientation, and the horizontal field East to West orientation has little effect on register, the magnetic shielding can be designed to minimize the effect of North and South orientation and keep the overall effects of the Earth's magnetic field to within the tolerance of the system. Such magnetic shielding systems are well known in the art.

Recently, the demand for large aspect ratio CRTs has led to the development of CRTs having a vertical electron gun orientation such that the plane in which the undeflected beams are located is parallel to the short axis or in other words on the vertical axis of the display screen. Along with vertical electron gun orientation, phosphor lines on the screen are arranged horizontally. In these CRTs, the vertical component of the ambient magnetic field causes electron beam displacements along the phosphor lines and ideally leaves the registration of the beams with respect to the phosphor pattern intact. Horizontal magnetic fields on the other hand can lead to first order register changes causing color impurities on the screen. Changing the CRT orientation from East to West reverses the direction of the register shift and it becomes significantly more difficult to design adequate shielding for all orientations, North, South, East, and West. Since the relationship between the tube orientation and the horizontal magnetic field is entirely under the control of the consumer, who will select it based on personal preference, it is desirable for a CRT having vertically aligned guns to be compensated for the register effects of this ambient magnetic field.

### SUMMARY

The invention provides a cathode ray tube (CRT) having a glass envelope. The glass envelope is formed of a rectangular faceplate panel and a tubular neck connected thereto by a funnel. An electron gun is positioned in the neck for directing electron beams toward the faceplate panel. A yoke is positioned in the neighborhood of the funnel-to-neck junction. The yoke has windings configured to apply a horizontal deflection yoke field and a vertical deflection yoke field to the beams. At least one magnetic field sensor is located near the glass envelope for sensing an ambient magnetic field environment of the CRT. A controller receives a signal from the magnetic field sensor. Register correction coils are mounted in the vicinity of the neck and are dynamically controlled by the controller to shift the beams. Quadrupole coils are applied to the neck and have adjacent poles of alternating polarity such that the resultant magnetic field being dynamically controlled by the controller based on the magnetic field sensor signal moves outer ones of the beams to correct the misconvergence caused by the register correction.

### BRIEF DESCRIPTION OF THE DRAWINGS

The invention will now be described by way of example with reference to the accompanying figures of which:

FIG. 1 shows a CRT according to the present invention;

FIG. 2 shows a block diagram according to the present invention;

FIG. 3 is a schematic representation showing register correction coils and related fields;

FIG. 4 is a schematic representation of a misconvergence pattern caused by the register correction coils;

FIG. 5 is a schematic representation of vertical quadrupole coils and related fields correcting the misconvergence pattern of FIG. 4; and,

FIG. 6 is a schematic representation of horizontal quadrupole coils and related fields correcting the misconvergence pattern of FIG. 4.

### DETAILED DESCRIPTION OF THE PREFERRED EMBODIMENTS

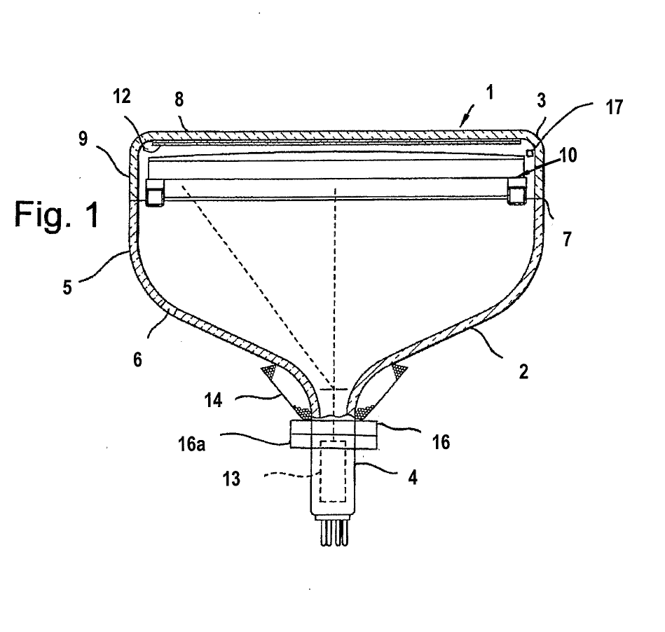

The invention provides an electronic compensation system having a sensor 17 which detects the orientation and magnitude of the local earth's magnetic field relative to that of the tube location and a set of compensation coils for correcting register errors that may be introduced by the local magnetic fields. FIG. 1 shows a cathode ray tube (CRT) 1, for example a W76 wide screen tube having a glass envelope 2 comprising a rectangular faceplate panel 3 and a tubular neck 4 connected by a funnel 5. The funnel 5 has an internal conductive coating (not shown) that extends from an anode button 6 toward the faceplate panel 3 and to the neck 4. The faceplate panel 3 comprises a viewing faceplate 8 and a peripheral flange or sidewall 9, which is sealed to the funnel 5 by a glass frit 7. A three-color phosphor screen 12 having a plurality of alternating phosphor stripes is carried by the inner surface of the faceplate panel 3. The screen 12 is a line screen with the phosphor lines arranged in triads, each of the triads including a phosphor line of each of the three colors. A mask assembly 10 is removably mounted in predetermined spaced relation to the screen 12. An electron gun 13, shown schematically by dashed lines in FIG. 1, is centrally mounted within the neck 4 to generate and direct three inline electron beams, a center beam and two side or outer beams, along convergent paths through the tension mask frame assembly 10 to the screen 12.

The electron gun 13 consists of three guns being vertically oriented, which direct an electron beam for each of three colors, red, green and blue. The red, green and blue guns are arranged in a linear array extending parallel to a minor axis of the screen 12. The phosphor lines of the screen 12 are accordingly arranged in triads extending generally parallel to the major axis of the screen 12. Likewise, the mask of the mask assembly 10 has a multiplicity of elongated slits extending generally parallel to the major axis of the screen 12. It should be understood by those reasonably skilled in the art that various types of tension or shadow mask assemblies which are well known in the art may be utilized.

The CRT 1 is designed to be used with an external magnetic deflection system having yoke 14 shown in the neighborhood of the funnel-to-neck junction. When activated, the yoke 14 subjects the three beams to magnetic fields which cause the beams to scan vertically and horizontally in a rectangular raster over the screen 12.

A magnetic field sensor 17 is positioned within or near the CRT 1. Although the magnetic field sensor 17 is shown in the embodiment of FIG. 1 as being located within the CRT 1 it should be understood that it could be located outside and near the CRT 1. For example, based on ease of manufacturability, the magnetic field sensor 17 may be positioned within a cabinet or enclosure which houses the CRT 1. Magnetic field sensor 17 may be for example a Hall effect sensor which is capable of detecting magnetic fields in a given axis. It should be understood by those reasonably skilled in the art that the magnetic field sensor 17 may be a single sensor capable of detecting magnetic fields in three axes or may alternatively be three separate sensors, one each for detecting magnetic fields along each major axis. Alternately, the magnetic field sensor 17 may be positioned at various locations within or near the CRT 1 in order to optimize detection of magnetic fields. Alternately, a plurality of magnetic field sensors 17 may be employed at various locations within or near the CRT. These magnetic fields sensor 17 output an electrical signal proportional to the ambient magnetic field incident thereon in a given direction. The magnetic fields sensor 17 therefore measures the ambient magnetic field environment of the CRT and it's output changes as the CRT is moved or relocated. When the horizontal component of the ambient magnetic field is changed (particularly East to West) there is a deflection of the beams vertically causing a register shift of the beam landing on the horizontal phosphor stripes. This register shift may degrade color purity.

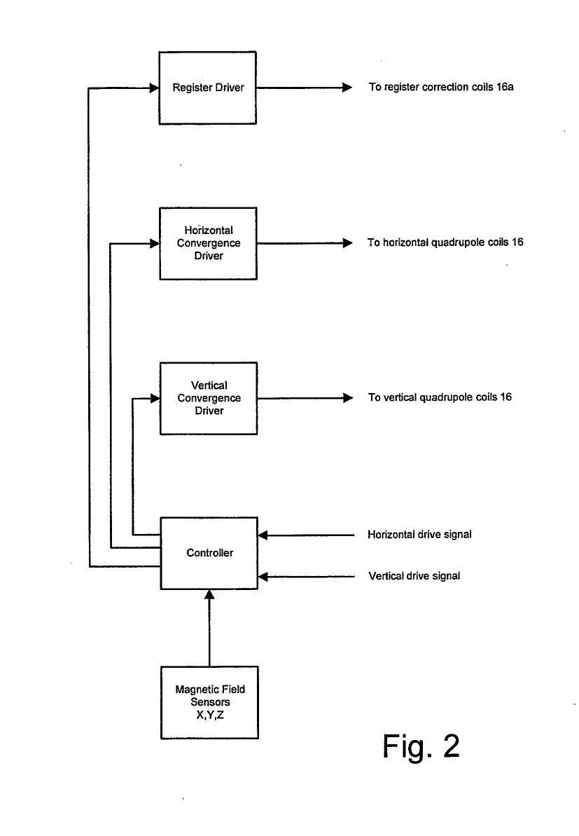

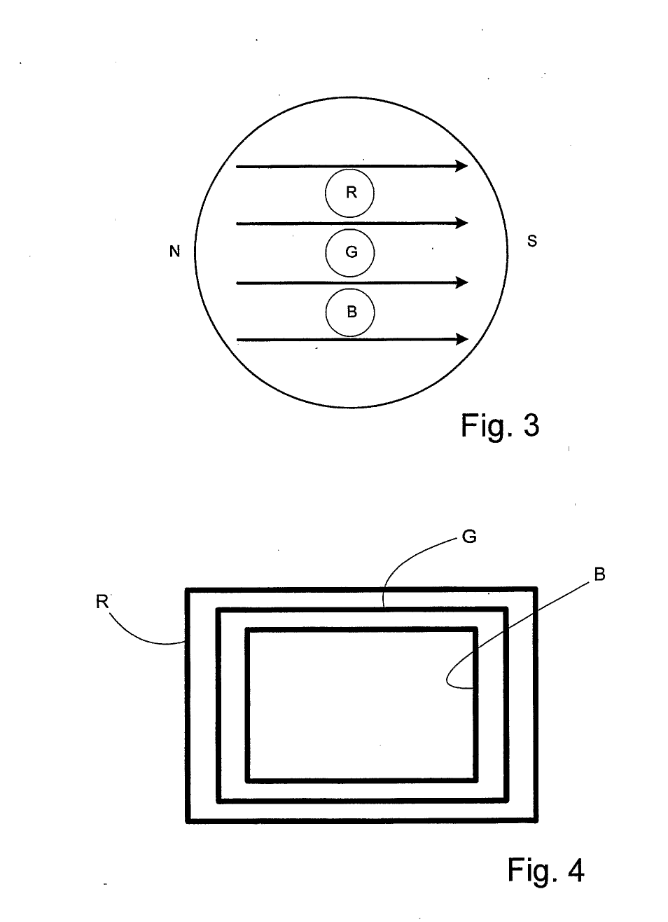

The output signal of the magnetic field sensor 17 is fed into a controller as shown in FIG. 2. The controller dynamically drives a set of register correction coils 16a preferably mounted in the neck region as shown in FIG. 1. It should be understood by those skilled in the art that the register correction coils 16a may also be referred to purity correction coils. The register correction coils 16a apply a relatively uniform field across the three beams, as shown schematically in FIG. 3, such that the three beams are uniformly deflected in the direction of the plane of the beams. This deflection moves each beam register normal to the phosphor stripes on the screen 12 so that it can be centered on the respective phosphor stripe. This purity correction, however causes the beams to shift or become misaligned within the yoke 14 resulting in misconvergence such as depicted in FIG. 4. Here it can be seen that the register correction and resultant beam misalignment within the yoke 14 causes an inward shift and an outward shift of the outer beams, specifically in this example, inward shift of the blue beam and outward shift of the red beam.

The yoke 14 and yoke effects will now be described in greater detail. The yoke 14 is positioned in the neighborhood of the funnel-to-neck junction as shown in FIG. 1 and, in this embodiment, is wound so as to apply a horizontal deflection yoke field which is substantially barrel shaped and a vertical deflection yoke field which is substantially pincushion shaped. The vertical pincushion shaped yoke field is generated by a first deflection coil system being wound on the yoke. The horizontal barrel shaped yoke field is generated by a second deflection coil system also being wound on the yoke such that it is electrically insulated from the first deflection coil system. Winding of the deflection coil systems is accomplished by known techniques. The yoke fields affect beam convergence and spot shape. These fields are generally adjusted to achieve self-convergence of the beams. Instead of adjusting for self-convergence, in the invention, the horizontal barrel field shape is adjusted, for example reduced, to give an optimized spot shape at the sides of the screen. The barrel shape of the field is reduced until an optimized nearly round spot shape is achieved at the 3/9 and corner screen locations. This field shape adjustment, resulting in improved spot shape, compromises self convergence causing misconvergence at certain locations on the screen. Specifically, the beams are overconverged at the sides. Overconvergence as used here describes a condition where the red and blue beams have crossed over each other prior to landing on the screen.

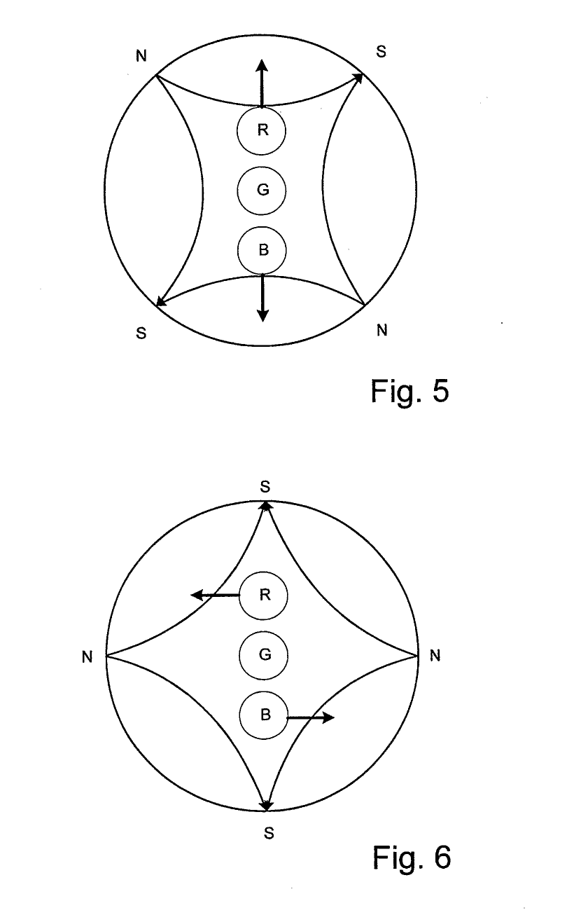

Correction of misconvergence that resulted from both the register correction and the yoke effects described above is achieved by addition of quadrupole coils 16 best shown in FIGS. 1, 5 and 6. Misconvergence from the yoke effect at locations along the screen 12 is dynamically corrected by quadrupole coils 16 located on the gun side of the yoke 14. Four or more quadrupole coils 16 are fixed to the yoke 14 or may alternatively be applied to the neck (FIG. 1) and each have four poles oriented at approximately 900 angles relative to each other as is know in the art. The quadrupole coils 16 include a first vertical set of quadrupole coils shown in FIG. 5 and a second horizontal set of quadrupole coils shown in FIG. 6. In the vertical set of quadrupole coils (FIG. 5), adjacent poles are of alternating polarity and the orientation of the poles is at 45° from the tube axes so that the resultant magnetic field moves the outer (red and blue) beams in a vertical direction as shown by the arrows in FIG. 5 to provide correction for the misconvergence. In the horizontal set of quadrupole coils (FIG. 6), adjacent poles are of alternating polarity and are orientated on the tube axes so that the resultant magnetic field moves the outer (red and blue) beams in a horizontal direction as shown by the arrows in FIG. 6 to provide correction for the misconvergence. Both sets of quadrupole coils 16 are located behind the yoke 14 such that they are approximately at or near the dynamic astigmatism point of the guns 13. The quadrupole coils 16 are dynamically controlled to create a correction field for adjusting miscovergence at locations on the screen. The quadrupole coils 16, in this embodiment are driven in synchronism with the horizontal deflection. The magnitude of the quadrupole driving waveform is selected to correct the overconvergence caused by the yoke field described above. In this embodiment the waveform is approximately parabolic in shape. The guns 13 in this embodiment have electrostatic dynamic focus (or astigmatism) correction in order to achieve optimum focus in both the horizontal and vertical directions on each of the three beams. This electrostatic dynamic astigmatism correction is done separately on each beam and allows correction of horizontal to vertical focus voltage differences without affecting convergence. Although the quadrupole coils 16 also effect beam focus, their location near the dynamic astigmatism point of the gun allows this effect to be corrected by adjusting the electrostatic dynamic astigmatism voltage of the gun such that the combination does not affect the resultant spot shape. This results in the favorable affect of being able to correct misconvergence at selected locations on the screen without affecting the spot shape. This allows the spot shape to be optimized by the yoke field design and any resultant misconvergence to be corrected by the dynamically driven quadrupole coils 16.

Color purity correction is accomplished by dynamically adjusting register correction coils 16a preferably mounted in the neck region. The register correction coils 16a apply a relatively uniform field across the three beams such that the three beams are uniformly deflected in the direction of the plane of the beams. This deflection moves each beam register normal to the phosphor stripes so that it can be centered on the respective phosphor stripe. Such coils could be integrated with the quadrupole coils 16 or, alternatively, integrated with the yoke 14 and yet again alternatively, located independently on the neck in the general region between the quadrupole coils 16 and yoke 14. Neck mounted register correction coils 16a cause beam displacements in addition to beam angle changes. The combination of these changes to the beam paths result in simultaneous register and convergence changes as these coils are activated. Therefore, dynamic programming of the quadrupole coils 16 in appropriate synchronization with the register correcting coils 16a is required in order to maintain simultaneously purity and convergence.

As shown in FIG. 2, a dynamic waveform generating controller is utilized to generate the required waveforms for convergence and register corrections. The fundamental inputs to the controller are the magnetic field data provided by a magnetic field sensor or sensors and timing signals provided by the horizontal and vertical drive signals. The controller contains appropriate memory and programming functions such that the dynamic waveforms can be set up according to the local magnetic configuration. The controller outputs signals to a register driver, a horizontal convergence driver and a vertical convergence driver. The register driver receives input from the controller and sends an output to drive register correction coils 16a of FIG. 1 accordingly. The horizontal convergence driver likewise receives an input signal from the controller to drive quadrupole coils 16 of FIG. 1 which affect horizontal convergence. Likewise, the vertical convergence driver receives input from the controller and sends and output signal to drive quadrupole coils 16 of FIG. 1 which affect vertical convergence. Other suitable types of multipole coils could be substituted for the quadrupole coils.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

1. A cathode ray tube comprising:
a glass envelope having a rectangular faceplate panel and a tubular neck connected thereto by a funnel;
an electron gun positioned in the neck for directing electron beams toward the faceplate panel;
a yoke positioned in the neighborhood of the funnel-to-neck junction, the yoke having windings configured to apply a horizontal deflection yoke field and a vertical deflection yoke field to the beams;
at least one magnetic field sensor located near the glass envelope for sensing an ambient magnetic field environment of the CRT;
a controller receiving a signal from the magnetic field sensor;
register correction coils being mounted in the vicinity of the neck and being dynamically controlled by the controller to shift the beams; and,
multipole coils applied to the neck and having adjacent poles of alternating polarity such that the resultant magnetic field being dynamically controlled by the controller based on the magnetic field sensor signal moves outer ones of the beams to correct a misconvergence caused by the register correction.

2. The CRT of claim 1 wherein the multipole coils are quadrupole coils, the quadrupole coils comprise a set of vertical quadrupole coils being oriented at 45° from the CRT axes such that the resultant magnetic field being dynamically controlled by the controller based on the magnetic field sensor signal moves outer ones of the beams vertically to correct the misconvergence.

3. The CRT of claim 2 wherein the quadrupole coils further comprise a set of horizontal quadrupole coils being oriented on the CRT axes such that the resultant magnetic field being dynamically controlled by the controller based on the magnetic field sensor signal moves outer ones of the beams horizontally to correct the misconvergence.

4. The CRT of claim 3 wherein the horizontal deflection yoke field is substantially barrel shaped the vertical deflection yoke field is substantially pincushion shaped.

5. The CRT of claim 1 wherein the electron gun has electrostatic astigmatism correction.

6. The CRT of claim 5 wherein the quadrupole coils are located in the vicinity of a dynamic astigmatism point of the electron gun such that adjustment of an electrostatic astigmatism voltage has no affect on spot shape.

7. The CRT of claim 3 wherein the quadrupole coils and register correction coils are dynamically controlled by the controller to maintain simultaneous purity and convergence.

8. The CRT of claim 7 wherein the controller further comprises a register driver, a horizontal convergence driver and a vertical convergence driver.

9. The CRT of claim 8 wherein the register driver is coupled to the register correction coils, the horizontal convergence driver is coupled to the horizontal quadrupole coils and the vertical convergence driver is coupled to the vertical quadrupole coils.

10. A cathode ray tube comprising:
a glass envelope having a rectangular faceplate panel and a tubular neck connected thereto by a funnel;
an electron gun positioned in the neck for directing electron beams toward the faceplate panel;
a yoke positioned in the neighborhood of the funnel-to-neck junction, the yoke having windings configured to apply a horizontal barrel shaped field and a vertical pincushion shaped field to the beams, the horizontal barrel field shape being adjusted to give an optimized spot shape at sides of the screen, causing an overconvergence of the beams at the sides of the screen;
at least one magnetic field sensor located near the glass envelope for sensing an ambient magnetic field environment of the CRT;
a controller receiving a signal from the magnetic field sensor;
register correction coils being mounted in the vicinity of the neck and being dynamically controlled by the controller to shift the beams; and,
quadrupole coils applied to the neck and having adjacent poles of alternating polarity such that the resultant magnetic field being dynamically controlled by the controller based on the magnetic field sensor signal moves outer ones of the beams to correct a misconvergence caused by the register correction coils, the quadrupole coils also being dynamically controlled by the controller to correct overconvergence at the sides of the screen caused by the yoke.

11. The CRT of claim 10 wherein the quadrupole coils comprise a set of vertical quadrupole coils being oriented at 45° from the CRT axes such that the resultant magnetic field being dynamically controlled by the controller moves outer ones of the beams vertically to correct the misconvergence.

12. The CRT of claim 11 wherein the quadrupole coils further comprise a set of horizontal quadrupole coils being oriented on the CRT axes such that the resultant magnetic field being dynamically controlled by the controller moves outer ones of the beams horizontally to correct the misconvergence.

13. The CRT of claim 10 wherein the electron gun has electrostatic astigmatism correction.

14. The CRT of claim 13 wherein the quadrupole coils are located in the vicinity of a dynamic astigmatism point of the electron gun such that adjustment of an electrostatic astigmatism voltage has no affect on spot shape.

15. The CRT of claim 10 wherein the quadrupole coils and register correction coils are dynamically controlled by the controller to maintain simultaneous purity and convergence.

16. The CRT of claim 15 wherein the controller further comprises a register driver, a horizontal convergence driver and a vertical convergence driver.

17. The CRT of claim 16 wherein the register driver is coupled to the register correction coils, the horizontal convergence driver is coupled to the horizontal quadrupole coils and the vertical convergence driver is coupled to the vertical quadrupole coils.
